(19) United States
(12) Patent Application Publication
(10) Pub. No.: US 2014/0251143 A1
(43) Pub. Date: Sep. 11, 2014

(54) FILTRATION SYSTEM FOR A GAS TURBINE AIR INTAKE AND METHODS

(71) Applicant: Donaldson Company, Inc., Minneapolis, MN (US)

(72) Inventors: Andrew James Hawkinson, Eden Prairie, MN (US); Eli Payton Ross, Morristown, MN (US); Jon Jerrold Haag, Vadnais Heights, MN (US)

(73) Assignee: Donaldson Company, Inc., Minneapolis, MN (US)

(21) Appl. No.: 14/199,385

(22) Filed: Mar. 6, 2014

Related U.S. Application Data
(60) Provisional application No. 61/774,676, filed on Mar. 8, 2013.

(51) Int. Cl. F02M 35/02; F02M 35/08; F02M 35/024

(52) U.S. Cl. CPC F02M 35/0216; F02M 35/0245; F02M 35/086
USPC 95/287; 55/482; 55/485; 55/302

(57) ABSTRACT

A gas turbine air filter system includes a housing having an interior, an inlet arrangement, and an outlet hood having an outlet arrangement. The inlet arrangement defines an inlet flow face for taking in unfiltered air. The outlet arrangement defines an outlet flow face for exiting filtered air. The inlet flow face and the outlet flow face are angled relative to each other. The angle can range between 45-135° relative to each other. The system includes at least first and second stages of filter element arrangements held within the interior of the housing. The first and second stages of filter element arrangements are operably sealed within the housing such that air flowing through the inlet arrangement must pass through the first and second stages of filter element arrangements before exiting through the outlet arrangement. The outlet hood is free of the first and second stages of filter element arrangements.

This application claims priority to U.S. Provisional Patent Application Ser. No. 61/774,676, filed Mar. 8, 2013, incorporated by reference herein in its entirety.

### TECHNICAL FIELD

This disclosure concerns filters and methods for use in filtering air for a gas turbine air intake.

### BACKGROUND

Inlet air filtration systems are generally employed for use with gas turbines and operate by removing salt, dust, corrosives, and water from inlet air to prevent their entry into the gas turbine and corrode and/or damage the gas turbine components. Gas turbine damage and corrosion can lead to operational inefficiencies or failures and financial loss.

It is desirable to have systems that can be easily retrofitted into existing systems. Further, it is desirable to have systems that can be easily adjusted to accommodate more or less stages of filtration, depending on the environment.

### SUMMARY

A filtration system for a gas turbine air intake is provided.

In one aspect, the system includes a housing having an interior, an inlet arrangement, and an outlet hood having an outlet arrangement. The inlet arrangement defines an inlet flow face for taking in unfiltered air. The outlet arrangement defines an outlet flow face for exiting filtered air. The inlet flow face and the outlet flow face are angled relative to each other. The angle can range between 45-135° relative to each other. The system includes at least first and second stages of filter element arrangements held within the interior of the housing. The first and second stages of filter element arrangements are operably sealed within the housing such that air flowing through the inlet arrangement must pass through the first and second stages of filter element arrangements before exiting through the outlet arrangement. The outlet hood is free of the first and second stages of filter element arrangements.

In one aspect, the at least first and second stages of filter element arrangements include at least a third stage of filter element arrangement operably sealed within the housing.

In one aspect, the at least first and second stages of filter element arrangements include a plurality of further stages of filter element arrangements operably sealed within the housing, each of the stages being either upstream or downstream of the other stages in the housing.

In one aspect, one of the at least first and second stages of filter element arrangement includes a pre-filter arrangement at or adjacent to the inlet arrangement. The pre-filter arrangement can be the most upstream stage of filter element arrangement.

In one aspect, the first stage of filter element arrangements includes a plurality of elements operably held by a first tubesheet in the interior of the housing.

In one aspect, the second stage of filter element arrangements includes a plurality of elements operably held by a second tubesheet in the interior of the housing. The second tubesheet is downstream of the first tubesheet.

In one aspect, the first tubesheet is +/−30° of being parallel to the inlet flow face. The second tubesheet is spaced from the first tubesheet and is +/−30° of being parallel to the first tubesheet.

In one aspect, the second tubesheet can include a series of steps.

In one aspect, the second stage filter element arrangement is oriented vertically above the first stage filter element arrangement, and the second stage filter element arrangement has a horizontal footprint that is smaller than a horizontal footprint of the first stage filter element arrangement.

In one aspect, the housing includes a base structure holding the first stage filter element arrangement spaced vertically above a base surface. The inlet flow face is between the base surface and the first stage filter element arrangement.

In one aspect, the inlet flow face and the outlet flow face are angled 70-110° relative to each other.

In one aspect, a pulse jet system is oriented within the housing interior and is disposed to periodically send a blast of fluid to the first stage filter element arrangement.

In one aspect, the system is a static system and is free of a pulse jet cleaning system.

In one aspect, the second stage filter element arrangement includes a plurality of filter elements having non-cylindrical and non-panel shaped media packs.

In one aspect, the second stage filter element arrangement includes a plurality of filter elements having pleated media and having a wave-shaped cross-section.

In one aspect, the first stage filter arrangement includes a plurality of cylindrical elements of pleated media.

In another aspect, a method of filtering air for a gas turbine system is provided. The method includes directing air to be filtered in through an inlet flow face of an inlet arrangement of a housing having an interior. The method may include directing the air through at least first and second stages of filter element arrangements held within the interior of the housing. The first and second stages of filter element arrangements are operably sealed within the housing such that air flowing through the inlet arrangement must pass through the first and second stages of filter element arrangements. The method may include directing the air through an outlet hood having an outlet arrangement defining an outlet flow face. The outlet flow face can be angled 45-135° relative to the inlet flow face. The outlet hood can be free of the first and second stages of filter element arrangements.

In one aspect, the step of directing the air through at least first and second stages of filter element arrangements includes directing the air through a plurality of further stages of filter element arrangements operably sealed within the housing, each of the stages being one of upstream or downstream of the other stages in the housing.

### BRIEF DESCRIPTION OF THE DRAWINGS

FIG. 1 is partially exploded perspective view one embodiment of a filtration system for a gas turbine air intake, constructed in accordance with principles of this disclosure;

FIG. 2 is a side view of the system of FIG. 1;

FIG. 3 is a front view of the system of FIG. 1 with a front skirt removed, the view being shown at section A-A in FIG. 2;

FIG. 4 is a top view of the system of FIG. 1;

FIG. 5 is a side cross-sectional view of the system of FIG. 1, the cross-section being taking along the line B-B of FIG. 4;

FIG. 6 is a schematic side view of another embodiment of a filtration system for a gas turbine air intake, constructed in accordance with principles of this disclosure;

FIG. 7 is a schematic side view of another embodiment of a filtration system for gas turbine air intake, constructed in accordance with principles of this disclosure;

FIG. 8 is a schematic side view of another embodiment of a filtration system for a gas turbine air intake, constructed in accordance with principles of this disclosure;

FIG. 9 is a schematic side view of another embodiment of a filtration system for a gas turbine air intake, constructed in accordance with principles of this disclosure; and

FIG. 10 is a schematic side view of another embodiment of a filtration system for a gas turbine air intake, constructed in accordance with principles of this disclosure.

### DETAILED DESCRIPTION

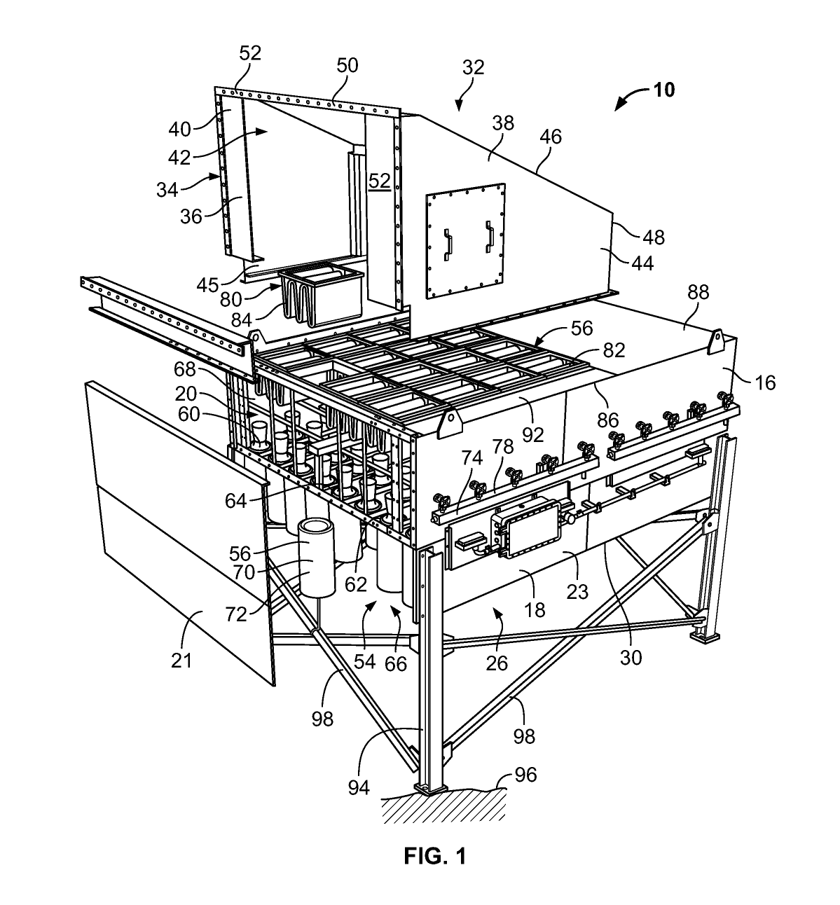

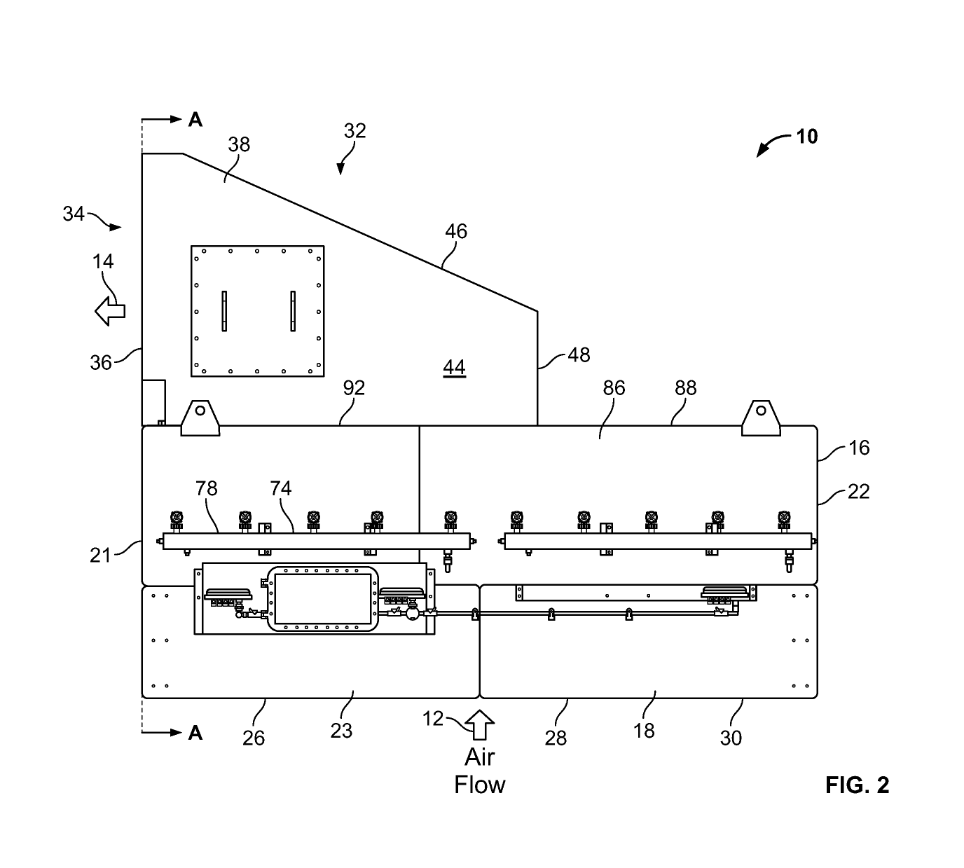

With reference to FIG. 1, a filtration system 10 for a gas turbine air intake is provided. In FIG. 2, the system is shown in side view. Air to be filtered is shown at arrow 12. The air 12 passes through the system 10, where it is filtered and then exits the system 10 at arrow 14, where it is then directed to a gas turbine (not shown).

In reference again to FIG. 1, in the embodiment shown, the system 10 includes a housing 16. The housing 16 includes a surrounding skirt 18. Inside of the skirt is an interior 20.

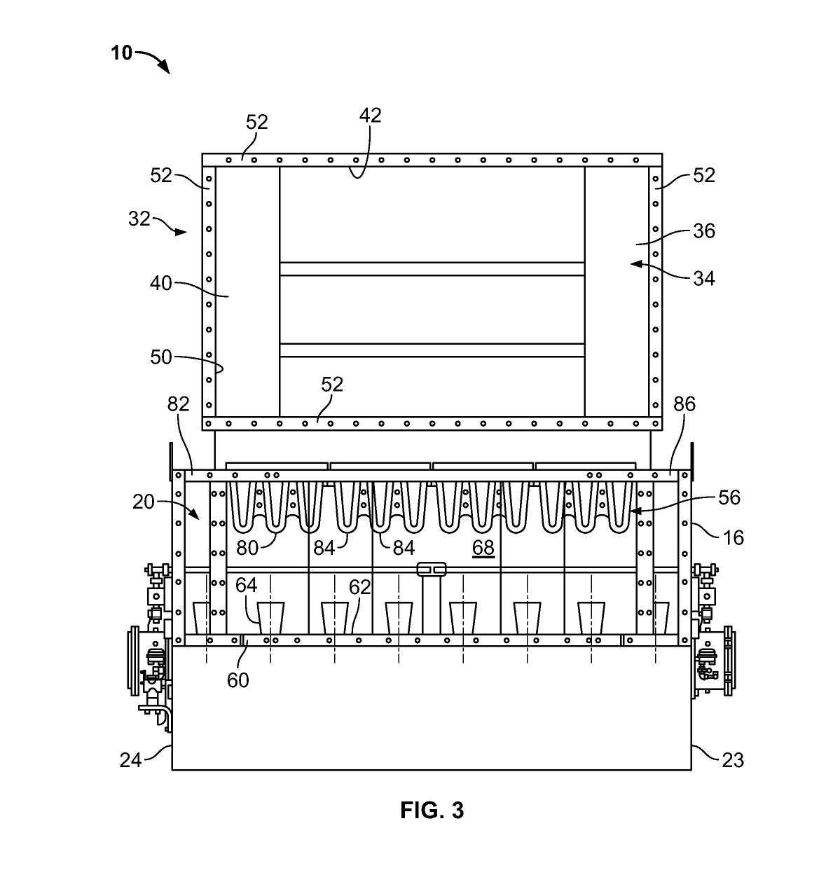

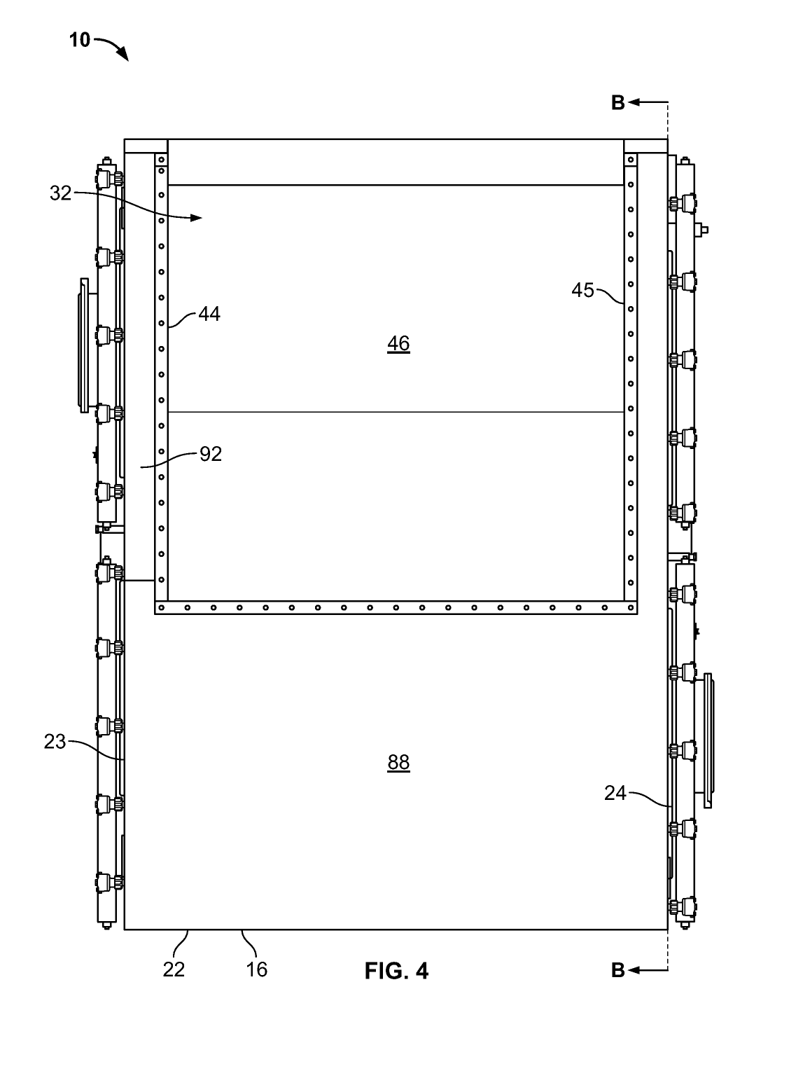

In one example embodiment, the skirt 18 includes a front panel 21, a rear panel 22 (FIGS. 2-5), a first side panel 23, and a second side panel 24 (FIGS. 3 and 4). In one example, the panels 21-24 can be made from a sheet metal.

The system 10 includes an inlet arrangement 26. The inlet arrangement 26 defines an inlet flow face 28. In general, the inlet flow face 28 can be approximated by the inner perimeter area defined by the lower edge 30 of the skirt 18. In this embodiment, the inlet flow face 28 is generally horizontal, when the system 10 is oriented in the configuration as shown in FIG. 1.

The inlet arrangement 26 is generally for taking in unfiltered air into the system 10. The system 10 removes particulate, including moisture droplets and debris, from the air before it exits at arrow 14, where it is then used for combustion by a gas turbine.

The system 10 further includes an outlet hood 32. The outlet hood 32 includes an outlet arrangement 34 defining an outlet flow face 36.

In the example embodiment shown, the outlet hood 32 includes a hood wall 38 and an opening 40. The hood wall 38 defines an outlet flow plenum 42 which is in communication with the interior 20 of the housing 16.

In the particular example shown, the hood wall 38 includes first and second sides 44, 45, opposing and spaced from each other, with a slanted roof 46 extending between the sides 44, 45. Also extending between the first and second sides 44, 45, and in opposition to the opening 40, is a rear side 48. The opening 40 can include an opening face 50 forming a periphery of the opening 40.

In this example, the outlet flow face 36 is formed by the perimeter area defined by the opening face 50. As can be seen in this particular example, the outlet flow face 36 is in a generally vertical plane, when the system 10 is oriented in the orientation shown in FIG. 1.

The opening face 50 defines flanges 52 that will allow the outlet hood 32 to be easily connected or bolted to existing or new duct work, leading to a gas turbine system.

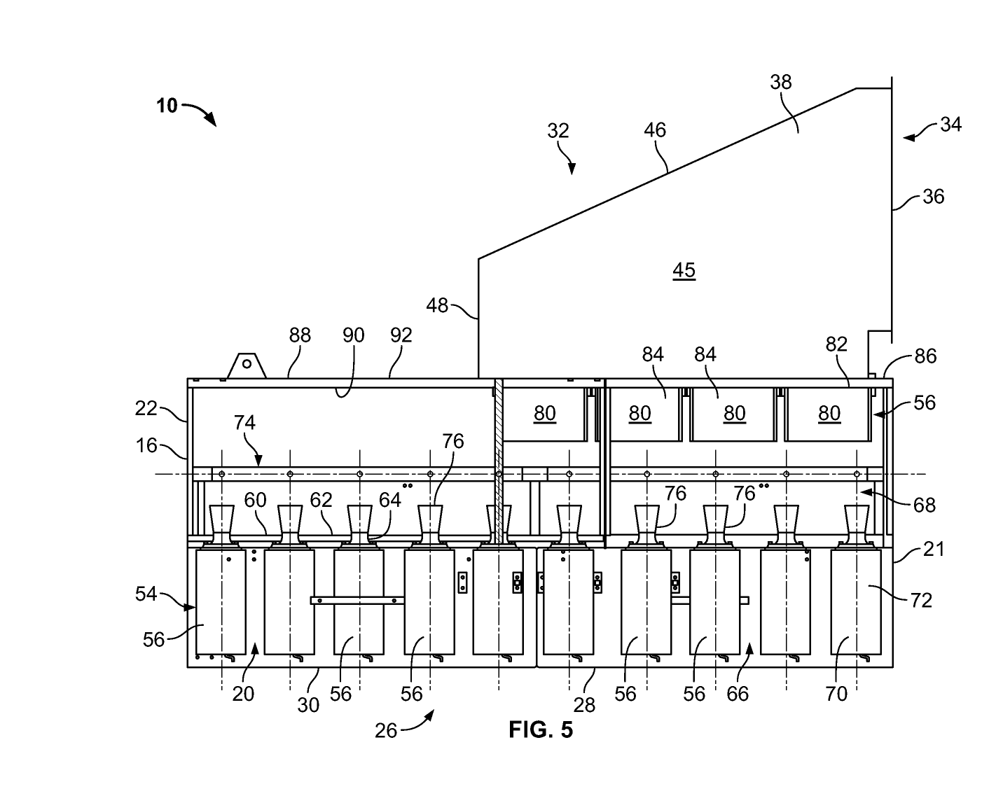

In general, the inlet flow face 28 and the outlet flow face 36 will be angled relative to each other. For example, the inlet flow face 28 and the outlet flow face 36 will be angled 45-135° relative to each other. Such angling of one relative to other allows for systems that can be easily adjusted to be retrofitted into existing systems and/or to accommodate more or less stages of filtration, depending upon what is needed in the particular environment of use. In some arrangements, the inlet flow face 28 and the outlet flow face 36 are angled about 70-110° relative to each other. In the particular example shown in FIGS. 2 and 5, the inlet flow face 28 and the outlet flow face 36 are angled 85-95° relative to each other, for example, about 90° relative to each other.

The system 10 includes at least a first stage filter element arrangement 54 and a second stage filter element arrangement 56 held within the interior 20 of the housing 16. The first and second stages 54, 56 are operably sealed within the housing 16 such that air flowing through the inlet arrangement 26 must pass through the first and second stages 54, 56 before exiting through the outlet arrangement 34. By the term “operably sealed” it is meant that the filter element arrangements are held and sealed within the housing 16 in a way that allows for the air to flow through the housing 16 and through the filter element arrangements 54, 56 so that the air is filtered by the filter element arrangements 54, 56. The first and second filter element arrangements 54, 56 may be removably sealed within the housing 16. Examples of first stage filter element arrangement 54 and second stage filter element arrangement 56 are described further below.

The outlet hood 32 is free of the first and second stages of filter element arrangements 54, 56. That is, the outlet hood 32, in preferred embodiments, does not hold or house either of the first stage filter element arrangement 54 or the second stage filter element arrangement 56. In some alternative embodiments, the outlet hood 32 may include some additional filtration, but the outlet hood 32 does not include the first and second stages 54, 56.

The housing 16 can include a base structure 94 (FIG. 1), which holds the first stage filter element arrangement 54 spaced vertically above a base surface 96. The base structure 94 can be a frame structure 98 secured to the remaining portion of the housing 16. As can be appreciated from a review of FIG. 1, the inlet flow face 28 is between the base surface 96 and the first stage filter element arrangement 54.

In one example, the first stage filter element 54 includes a plurality of filter elements 56 operably held by a first tubesheet 60 in the interior 20 of the housing 16. The first tubesheet 60, in the example of FIGS. 1, 3, and 5, is a panel or partition 62 including apertures 64. Each aperture 64 holds an individual filter element 58, which is sealed against the partition 62. The first tubesheet 60 divides the interior 20 between an unfiltered air volume 66 and a filtered air volume 68. In the embodiment shown in FIGS. 1, 3, and 5, the first tubesheet 60 is generally horizontal, when shown in the orientation as depicted in FIG. 1. The tubesheet 60 is also, in this example embodiment, generally parallel to the inlet flow face 28.

Many different embodiments of filter elements 56 can be used. In the embodiment shown in FIG. 1, the filter elements 56 are depicted as cylindrical elements 70 having pleated media 72. For example, usable filter elements 56 include those described in U.S. Pat. No. 5,562,746, incorporated herein by reference. Other types of elements could include panel elements of pleated, depth, or Z-media; v-packs of pleated, depth, or Z-media; pocket filters; mini-pleats, etc.

The system 10 can include a pulse jet system 74 within the interior 20 of the housing 16 disposed to periodically send a blast of fluid to the first stage filter element arrangement 54. For example, the pulse jet system 74 can be oriented such that a jet of air is periodically blasted from the downstream side of the filter elements 58 through the upstream side, to remove any caked on particulate or debris. The pulse jet system 74 can include venturi members 76 to help direct the pulse jet to the downstream side of the media through a media to the upstream side. In FIGS. 1 and 2, the pulse jet system 74 can be seen with system components 78.

In alternate systems, the system 10 will be a static system that is free of a pulse jet cleaning system.

The second stage filter element arrangement 56 can include a variety of different types of filter elements. In the example shown in FIGS. 1-5, the second stage filter element arrangement 56 includes a plurality of filter elements 80. The filter elements 80 are operably held by a second tubesheet 82 in the interior 20 of the housing 16. The second tubesheet 82 is downstream of the first tubesheet 60.

In one example, the first tubesheet 60 is +/−45° of being parallel to the inlet flow face 28, and the second tubesheet 82 is spaced from the first tubesheet 60 and is +/−30° of being parallel to the first tubesheet 60. In the example shown in FIG. 1, the first tubesheet 60 is approximately parallel to the inlet flow face 28, and the second tubesheet 82 is about parallel to the first tubesheet 60.

While a variety of different arrangements can be used for the filter elements 80 that are part of the second stage filter element arrangement 56, in the particular example shown in FIG. 1, the filter elements 80 are non-cylindrical elements.

In non-limiting examples, the filter elements 80 in the second stage arrangement 56 are non-panel shaped media packs. In other arrangements, the filter elements 80 can be cylindrical. In other arrangements, the filter elements 80 can be panel shaped elements.

In the particular example illustrated in FIG. 1, the second stage filter element 56 includes elements 84 having a wave-shaped cross-section of pleated media. In one non-limiting example, elements 84 that can be utilized are described in U.S. Patent Publication US 2011/0067368, published Mar. 24, 2011, and incorporated herein by reference. In other embodiments, the second stage elements 80 can be v-packs, pocket elements, mini-pleats, panel filters, z-media, tubular filters, etc.

In the example shown in FIG. 1, the second tubesheet 82 is at or adjacent to the top edge 86 of the skirt 18 of the housing 16. In the example shown, the second stage filter element arrangement 56 is oriented vertically above the first stage filter element arrangement 54. While there can be an angle between the two, in the example shown, the first stage 54 and second stage 56 are generally parallel to each other.

Attention is directed to FIG. 5. In FIG. 5, in the example shown, the first stage 54 can be seen relative to the second stage 56. By comparing FIG. 1 and FIG. 5, it can be appreciated that the second stage 56 has a horizontal footprint that is smaller than a horizontal footprint of the first stage 54. That is, the first stage filter element arrangement 54 occupies most of the volume of the interior 20 between front panel 21 and rear panel 22, as well as between first and second side panels 23, 24 of the skirt 18. In contrast, the second stage 56 occupies only a portion of the interior 20 between the front panel 21 and rear panel 22. In the example shown, the second stage 56, in this example, extends between the first side panel 23 and second side panel 24, but it extends only partially from the front panel 21 to the rear panel 22.

In the example shown in FIGS. 1 and 5, the second stage 56 extends less than 100%, for example between 40-70% of the extension of the horizontal footprint of the first stage element 54. In the example of FIGS. 1 and 5, the second stage arrangement 56 extends from the front panel 21 about 45-65% to the rear panel 22. Thus, in the embodiment shown in FIGS. 1 and 5, the housing 16 includes a top panel 88, which extends between and end of the second stage 56 and the rear panel 22. The top panel 88 covers the first stage 54 and defines a plenum 90 (FIG. 5) between the first tubesheet 60 and the top panel 88 leading to the second stage 56.

In the example shown, the outlet hood 32 forms a horizontal footprint defined as an inside periphery of the hood wall 38. That is, in the example embodiment shown, the outlet hood 32 has a horizontal footprint defined by an inner periphery of the first side 44, second side 45, rear side 48, and along the front edge 51 of the opening face 50. The horizontal footprint of the outlet hood 32 is preferably within about 20% of a size of the horizontal footprint of the second stage filter arrangement 56. In many preferred arrangements, the horizontal footprint of the outlet hood 32 and of the second stage filter arrangement 56 are within 10% of each other, and can be about the same size as each other.

From a review of FIGS. 1 and 2, it can be appreciated that the horizontal footprint of the outlet hood 32 is less than the horizontal footprint of the first stage filter arrangement 54. In the example shown, the horizontal footprint of the outlet hood 32 extends from the front panel 21 not more than 80% of the distance toward the rear panel 22 across a top 92 of the housing 16. In many preferred arrangements, the outlet hood 32 extends less than 75% of the distance across the top of 92 of the housing 16 between the front panel 21 and rear panel 22. Typically, the outlet hood 32 extends at least 15% of the distance across the top 92 of the housing 16 between the front panel 21 and rear panel 22, and can extend between 45-100% of the distance across the top 92 of the housing 16.

In operation, to filter incoming air, the unfiltered air enters the system 10 at arrows 12 (FIG. 2). As can be seen, the air entering system 10, in this embodiment, is located below the first stage filter element arrangement 54. In this embodiment, the air 12 enters through the inlet arrangement 26 having inlet flow face 28. The inlet flow face 28, in this particular embodiment, is generally horizontal.

After the air enters the system 10 through the inlet flow face 28, the air is directed through the first stage filter element arrangement 54. When the first stage filter element arrangement 54 includes cylindrical filter elements 70, the air flows from the outside of the elements, through the filter media, and into the interior of each of the elements 70. From there, the air flows into filtered air volume 68. At least some of the air in the filtered air volume 68 is within plenum 90 between the top panel 88 and the first tubesheet 60. The filtered air in the filtered air volume 68, including the air in the plenum 90 is then directed through the second stage filter element arrangement 56. The air flows through the filter media in the second stage filter element arrangement 56 and is then directed into the plenum 42 of the outlet hood 32. The clean filtered air then flows through the outlet flow face 36 of the outlet arrangement 34, where it is then directed to a gas turbine system for combustion.

During the step of directing the air through the outlet hood 32, the outlet flow face 36 is angled 45-135° relative to the inlet flow face 28. In many typical arrangements, this angle would be 80-100°, approximately 90°. The outlet hood 32 will be free of both the first and second stages 54, 56, which enhances flexibility of the system 10.

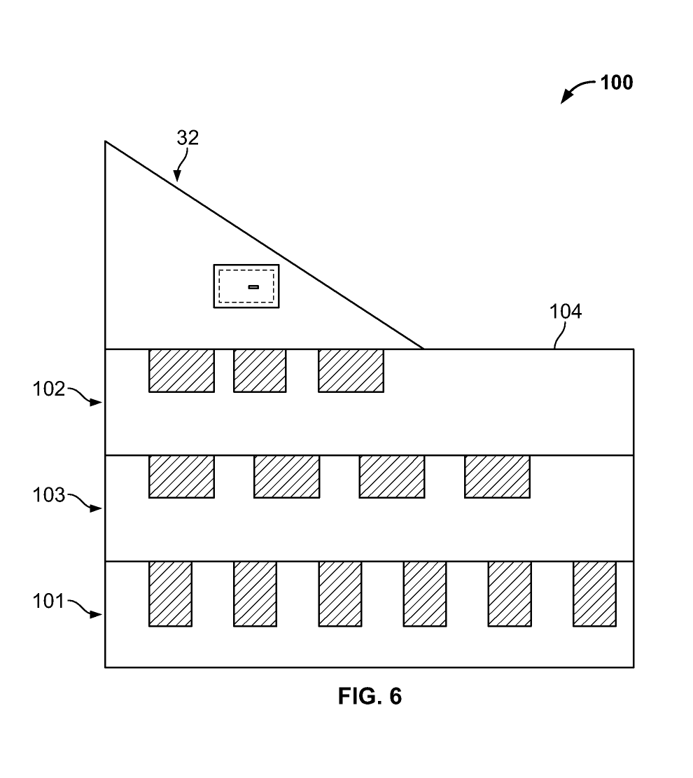

The system 10 is arranged so that it is adapted to be flexible enough to accommodate more than just first and second stages 54, 56. In FIG. 6, there is a system 100 that has, in addition to the first stage 101 and second stage 102, a third stage 103 of a filter element arrangement operably sealed within the housing 104. The system 100 is constructed analogously to the system 10, but is modified to include, within the same original horizontal footprint of housing 16, the third stage 103. That is, the housing 104 can be built by modifying the housing 16 to include additional height to the skirt 18 in order to accommodate a plurality of additional stages of filter elements. In FIG. 6, the third stage 103 is illustrated, but it should be understood that there can be more than three stages, with each of the additional stages being either upstream or downstream of the other stages in the housing 104. In the example of FIG. 6, the third stage 103 is shown between the first stage 101 and second stage 102. The additional stages would be accommodated within the housing 104, without extending beyond the horizontal footprint of the housing 104 (or housing 16, as illustrated in FIGS. 1-5).

In FIG. 6, the elements within each of the stages can be a variety of types of filter elements, depending upon the environment of use and the particular objectives.

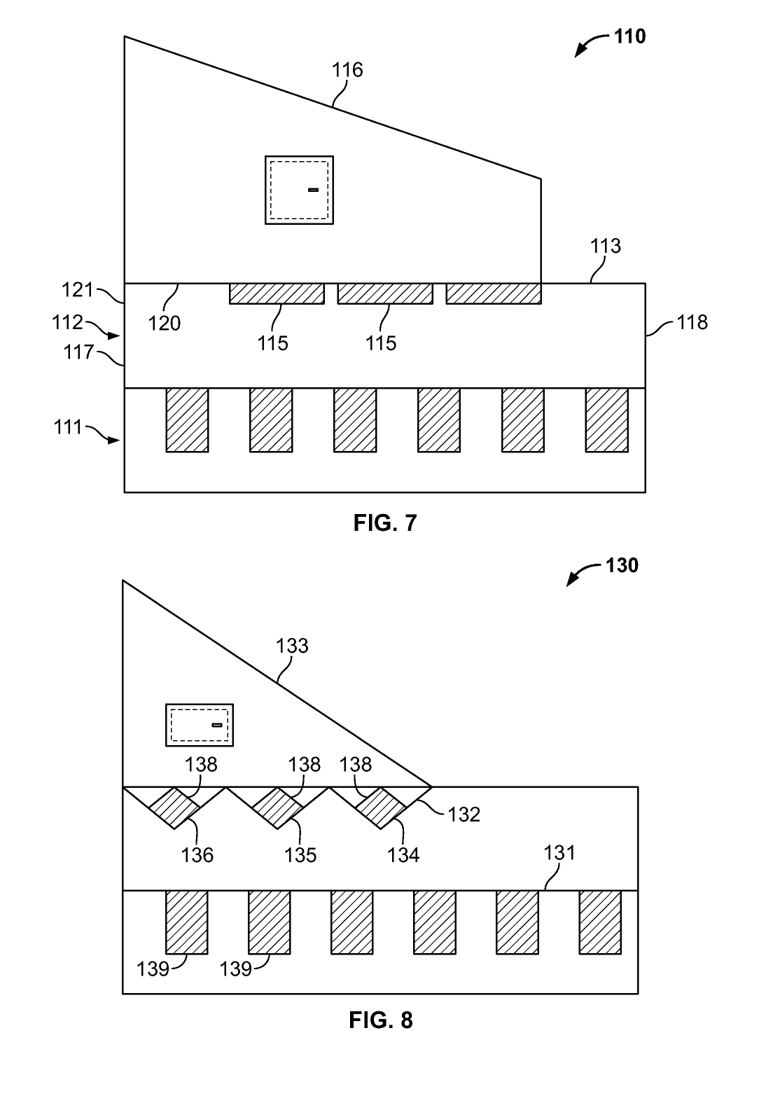

FIG. 7 illustrates another system 110. In FIG. 7, the first stage is shown at 111 and the second stage is shown at 112 within housing 113. Again, the system 110 is analogous to the system 10, and description thereof is incorporated herein by reference. One difference between the system 10 and system 110 is that the second stage 112 in this embodiment is illustrated as having panel filters 115. The outlet hood 116 extends a distance to cover the second stage 112, and does not extend a full length of the housing 113 between a front panel 117 and rear panel 118.

In FIG. 7, the second tubesheet 120 is generally centered between the front panel 117 and rear panel 118. That is, instead of having filter elements right up to the front edge 121, as shown in the system of FIG. 1, in FIG. 7, because the second tubesheet 120 is centered, the panel filter elements 115 are spaced from the front edge 121.

While in previous embodiments, the tubesheets have been shown to be generally planar, they do not necessarily have to be so. For example, FIG. 8 illustrates a system 130 having first and second tubesheets 131, 132, with second tubesheet 132 being non-planar. In the embodiment shown, the second tubesheet 132 has a series of steps 134, 135, 136 to be saw-tooth shaped. Each step 134, 135, 136 operably holds a filter element 138. The first tubesheet 131 holds elements 139, which can be many different types of elements including cylindrical pleated elements, such as shown in connection with FIG. 1. The elements 138 held by the second tubesheet 132 can be many different types of elements including, for example, panel elements, pocket filters, v-packs, wave-shaped, etc. Other than the shape of the second tubesheet 132, the system 130 is analogous to the system 10 of FIGS. 1-5, and the description is incorporated herein by reference. The system 130 includes an outlet hood 133.

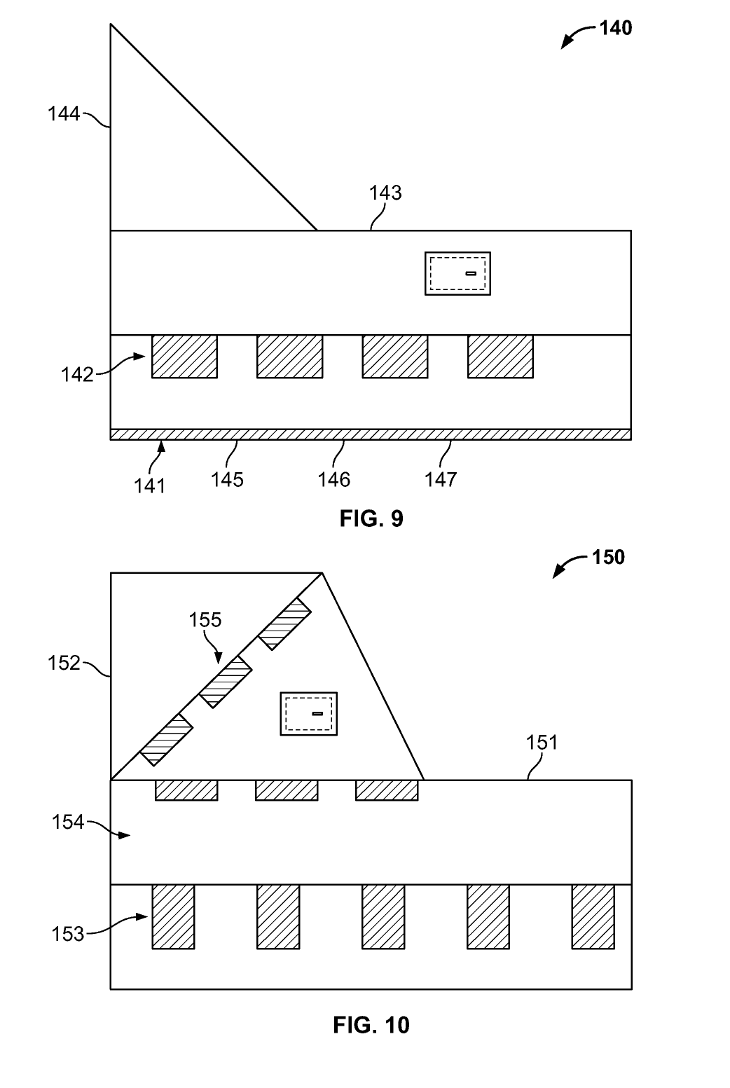

FIG. 9 shows another embodiment of a system at 140. The system 140 is analogous to the system 10, in that it has first and second stages 141, 142 in a housing 143. An outlet hood 144 directs the filtered air from the housing 143.

In the embodiment of FIG. 9, one of the at least first and second stages 141, 142 includes a pre-filter arrangement 145 at or adjacent to the inlet arrangement 146. In the particular example shown in FIG. 9, the first stage 141 is also the pre-filter arrangement 145.

The pre-filter arrangement 145 can be many different types of filters including a porous screen 147. The screen 147 can be in place to prevent birds, tree branches, leaves, and large debris, for example, from being drawn into the housing 143.

After the air passes through the pre-filter arrangement 145, it then passes through the second stage 142. From there, in the embodiment shown, the air is directed through the hood 144 and exits the system 140. There can be at least one or more than one stage downstream of the pre-filter arrangement 145, but in the embodiment of FIG. 9, only a single stage downstream of the pre-filter arrangement 145 is illustrated.

FIG. 10 illustrates another embodiment of an air intake filter system at 150. The system 150 is analogous to the system 10, and the description of the system 10 is incorporated herein by reference. The system 150 includes housing 151, outlet hood 152, and a plurality of stages of filter arrangements. In the FIG. 10 embodiment, there are three stages illustrated, the first stage at 153, second stage at 154 and third stage at 155.

In the system 150, the third stage 155 is held within the hood 152. The elements in the third stage 155 can be many different types of filter elements including panel filters made of pleated media, depth media, or z-media; wave-shaped elements, pocket filters, v-packs, or cylindrical elements, etc. It should be understood that the illustrated embodiment of FIG. 10 shows only first and second stages 153, 154 upstream of the third stage 155, but in other embodiments, there can be more than just the first and second stages 153, 154.

To service any of the systems described above, the elements in the first stage 54 are accessed through the inlet arrangement 26, and the elements in the second stage 56 are accessed through a hatch or access panel in the housing 16. After a period of operation, it will become necessary to remove the elements in each stage and replace them with new elements. Not all stages will necessarily need servicing at the same time. The stages downstream of the most upstream stages may need servicing less frequently than the most upstream stage. During servicing, the elements are removed and replaced with new filter elements.

The above specification, examples and data provide a complete description of principles. Many embodiments can be made applying these principles.

What is claimed is:

1. An air intake filter system for a gas turbine inlet; the air intake filter system comprising:
(a) a housing having an interior, an inlet arrangement defining an inlet flow face for taking in unfiltered air, and an outlet hood having an outlet arrangement defining an outlet flow face for exiting filtered air;
(i) the inlet flow face and the outlet flow face being angled 45-135° relative to each other;
(b) at least first and second stages of filter element arrangements held within the interior of the housing; the first and second stages of filter element arrangements being operably sealed within the housing such that air flowing through the inlet arrangement must pass through the first and second stages of filter element arrangements before exiting through the outlet arrangement; and
(c) the outlet hood being free of the first and second stages of filter element arrangements.

2. The air intake filter system of claim 1 wherein:
(a) the at least first and second stages of filter element arrangements include at least a third stage of filter element arrangement operably sealed within the housing.

3. The air intake filter system of claim 1 wherein:
(a) the at least first and second stages of filter element arrangements includes a plurality of further stages of filter element arrangements operably sealed within the housing, each of the stages being one of upstream or downstream of the other stages in the housing.

4. The air intake filter system of claim 1 wherein:
(a) one of the at least first and second stages of filter element arrangements includes a pre-filter arrangement at or adjacent to the inlet arrangement.

5. The air intake filter system of claim 1 wherein:
(a) the first stage of filter element arrangements includes a plurality of elements operably held by a first tubesheet in the interior of the housing.

6. The air intake filter system of claim 1 wherein:
(a) the second stage of filter element arrangements includes a plurality of elements operably held by a second tubesheet in the interior of the housing; the second tubesheet being downstream of the first tubesheet.

7. The air intake filter system of claim 6 wherein:
(a) the first tubesheet is +/−30° of being parallel to the inlet flow face; and
(b) the second tubesheet is spaced from the first tubesheet and is +/−30° of being parallel to the first tubesheet.

8. The air intake filter system of claim 6 wherein:
(a) the second tubesheet includes a series of steps.

9. The air intake filter system of claim 1 wherein:
(a) the second stage filter element arrangement is oriented vertically above the first stage filter element arrangement.

10. The air intake filter system of claim 1 wherein:
(a) the housing includes a base structure holding the first stage filter element arrangement spaced vertically above a base surface; and
(b) the inlet flow face is between the base surface and the first stage filter element arrangement.

11. The air intake filter system of claim 1 wherein:
(a) the inlet flow face and the outlet flow face are angled 70-110° relative to each other.

12. The air intake filter system of claim 1 further including:
(a) a pulse jet system oriented within the housing interior and disposed to periodically send a blast of fluid to the first stage filter element arrangement.

13. The air intake filter system of claim 1 wherein:
(a) the system is a static system and is free of a pulse jet cleaning system.

14. The air intake filter system of claim 1 wherein:
(a) the second stage filter element arrangement includes a plurality of filter elements having non-cylindrical and non-panel-shaped media packs.

15. The air intake filter system of claim 1 wherein:
(a) the second stage filter element arrangement includes a plurality of filter elements having pleated media and having a wave-shaped cross-section.

16. The air intake filter system of claim 1 wherein:
(a) the first stage filter element arrangement includes a plurality of cylindrical elements of pleated media.

17. A method of filtering air for a gas turbine system; the method comprising:
(a) directing air to be filtered in through an inlet flow face of an inlet arrangement of a housing having an interior,
(b) then directing the air through at least first and second stages of filter element arrangements held within the interior of the housing; the first and second stages of filter element arrangements being operably sealed within the housing such that air flowing through the inlet arrangement must pass through the first and second stages of filter element arrangements; and
(c) then directing the air through an outlet hood having an outlet arrangement defining an outlet flow face;
(i) the outlet flow face being angled 45-135° relative to the inlet flow face;
(ii) the outlet hood being free of the first and second stages of filter element arrangements.

18. The method of claim 17 wherein:
(a) the step of directing the air through at least first and second stages of filter element arrangements includes directing the air through a plurality of further stages of filter element arrangements operably sealed within the housing, each of the stages being one of upstream or downstream of the other stages in the housing.
